(19) United States
(12) Patent Application Publication
(10) Pub. No.: US 2008/0246236 A1
(43) Pub. Date: Oct. 9, 2008

(54) Multiple-Section Recreational Board

(76) Inventors: Frank Lombano, Lodi, CA (US); Lance A. Maki, Merritt Island, FL (US)

Correspondence Address: PATENT ADMINISTRATOR;KATTEN MUCHIN ROSENMAN LLP, 2900 K Street NW, Suite 200, WASHINGTON, DC, 20007-5118, US

(21) Appl. No.: 10/592,835

(22) PCT Filed: Mar. 16, 2005
(86) PCT No.: PCT/US05/08691

§ 371 Date: Sep. 14, 2006

Related U.S. Application Data
(60) Provisional application No. 60/533,585, filed on Dec. 31, 2003.

(51) Int. Cl. F16B 12/36; B23P 11/00

(52) U.S. Cl. 280/18; 403/292; 403/293; 29/428

(57) ABSTRACT

A multiple-section recreational board is formed in two or more sections. Contiguous sections of the recreational board arc coupled together by one or more bridges which provide the structural integrity generally equivalent to an integral one piece recreational board. The bridges may be latched by an integral or separate latch mechanism. In accordance with one aspect of the invention, the multiple-section recreational boards are relatively easily disassembled and reassembled and are relatively less complex to manufacture than known multiple-section recreational boards.

### CROSS REFERENCE TO RELATED APPLICATIONS

This application claims priority to and the benefit of U.S. provisional patent application No. 60/553,585, filed Mar. 16, 2004, hereby incorporated by reference.

### BACKGROUND OF THE INVENTION

1. Field of the Invention

The present invention relates to a recreational board, such as a snowboard, a surfboard, skis, and the like, and more particularly to a multiple-section recreational board, which can be easily disassembled to facilitate transport and reassembled quickly and easily while providing sufficient structural integrity.

2. Description of the Prior Art

Various multiple-section snowboards and skis are known in the art. For example, U.S. Pat. Nos. 2,545,209; 3,026;546; 3,439,928; 3,797,838; 3,819,198; 3,825,360; 4,155,568; 4,458,912; 4,593,926; 4,600,211; 4,645,228; and 4,723,789 all disclose multiple-section skis that are split along a transverse axis. Such multiple-section skis facilitate transport. Unfortunately, the multiple-section skis disclosed in these patents are relatively complicated and are not user-friendly.

Other known examples of such multiple-section skis are disclosed in U.S. Pat. Nos. 3,104,888; 4,358,130; 4,632,418 and 6,616,170. Unfortunately, the connection mechanisms in these devices are relatively complicated making the skis relatively complex and thus expensive to manufacture and repair.

U.S. Pat. No. 5,711,692 relates to a multiple-section surfboard. Contiguous sections of the surfboard are coupled together with a rod arrangement. More particularly, one section of the surfboard is provided with a rod extending outwardly from the width of the surfboard and disposed along the board's longitudinal axis. The other section of the surfboard is provided with an elongated hole for receiving the rod. The arrangement is configured so that when the rod is received in the elongated hole, the contiguous sections of the surfboard are aligned. A latch device is provided to latch the two contiguous sections together. Although such an arrangement for coupling together multiple sections of a surfboard may provide acceptable performance-for a surfboard, such a configuration is not appropriate for recreational boards where the forces involved can be expected to be relatively high.

Thus, there is a need for a multiple-section recreational board that is user-friendly and is also relatively less complicated and thus less expensive to manufacture and is suitable for applications in which the expected forces are relatively high.

### SUMMARY OF THE INVENTION

Briefly, the present invention relates to a multiple-section recreational board, such as a snowboard, surfboard, skis, or the like. The multiple-section recreational board may be formed in two or more sections. Contiguous sections of the recreational board are coupled together by one or more bridges in order to provide sufficient structural integrity generally equivalent to or greater than a one-piece recreational board. The board sections may be latched together by one or more latch mechanisms that are relatively simpler than known latch mechanisms. The latch mechanisms may be either separate devices or integrally formed with the bridge. In accordance with one aspect of the invention, the multiple-section recreational board is relatively easily disassembled and reassembled and is relatively less complex to manufacture than known multiple section recreational boards.

### DESCRIPTION OF THE DRAWING

These and other advantages of the present invention will be readily understood with reference to the following specification and attached drawing wherein:

FIG. 1 is a top view of an exemplary embodiment of a two piece recreational board in accordance with the present invention that has been joined together with a bridge consisting of a plate and a number of fasteners.

FIG. 2 is an isometric view of the two-piece recreational board illustrated in FIG. 1.

FIG. 3a is a top view of an alternate embodiment of a bridge that may be used to join contiguous sections of a recreational board together in accordance with the present invention.

FIG. 3b is a side view of the bridge illustrated in FIG. 3a.

FIG. 3c is an end view of the bridge illustrated in FIG. 3a.

FIG. 4a is another alternate embodiment of a bridge that may be used to join contiguous sections of a recreational board together in accordance with the present invention.

FIG. 4b is a side view of the bridge illustrated in FIG. 4a.

FIG. 4c is an end view of the bridge illustrated in FIG. 4a.

FIG. 4d is a sectional view along line 4d-4d of FIG. 4a.

FIG. 4e illustrates a multiple-section recreational board with a plurality of bridges illustrated in FIG. 4a.

FIG. 5 is an isometric view of another alternate embodiment of a bridge that may be used to join split sections of a recreational board together in accordance with the present invention, shown mounted on a portion of a recreational board in a disassembled position.

FIG. 6 is similar to FIG. 5 but illustrating a smooth covering for the bridge.

FIG. 7 illustrates an alternate embodiment of the bridge illustrated in FIG. 5 but with an integral latch mechanism.

FIG. 8 is an isometric view of another alternate embodiment of a bridge that may be used to join contiguous sections of a recreational board together in accordance with the present invention, shown mounted on a portion of a recreational board in a disassembled position and also illustrating an separate exemplary latch mechanism.

FIGS. 9a and 9b are isometric views of another alternate embodiment of a bridge that may be used to join split sections of a recreational board together in accordance with the present-invention, shown in an assembled and disassembled positions, respectively.

FIGS. 10a and 10b are isometric views of another alternate embodiment of a bridge with an integral latch that may be used to join contiguous sections of a recreational board together in accordance with the present invention, shown in an assembled and disassembled positions, respectively.

FIG. 11a is an isometric view of an alternate bridge with an integral latch for use with the present invention, shown in a latched position.

FIG. 11b is similar to FIG. 11a but shown in a disassembled position.

FIG. 11c is similar to FIG. 11a but shown in an intermediate unlatched position.

### DETAILED DESCRIPTION

The present invention relates to a multiple-section recreational board. Although the invention is described and illustrated with respect to a multiple-section snowboard, the principles of the present invention are also applicable to multiple-section skis, as well as multiple-section surfboards, for example, as described in U.S. Pat. No. 5,711,692. As used herein, multiple section recreational board refers to all types of recreational boards including snowboards, surfboards, skis and the like. Moreover, although the multiple-section recreational board is shown and illustrated split into just two sections, the principles of the present invention also relate to recreational boards that are split into more than two sections, for example, three sections or more.

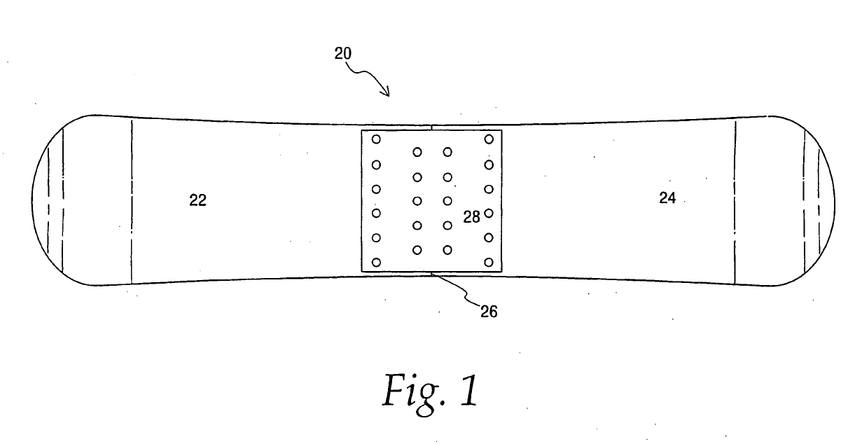

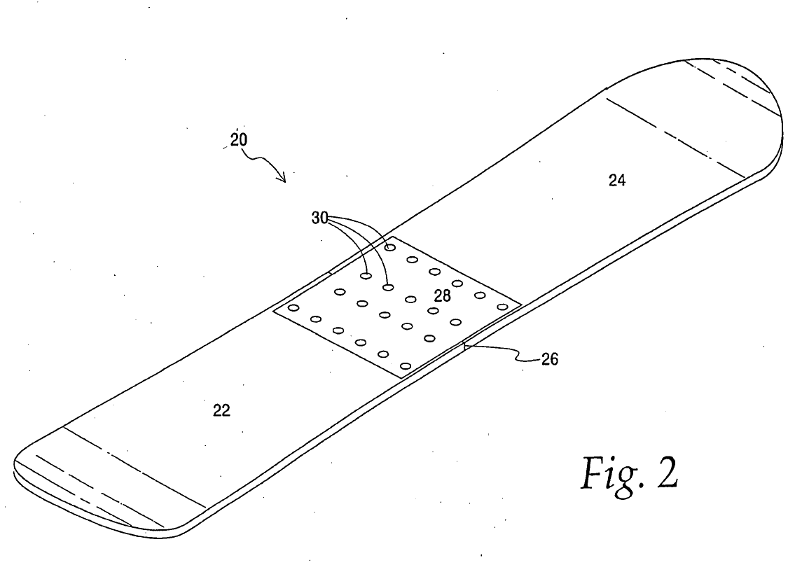

Turning to the drawing, FIGS. 1 and 2 illustrate the simplicity of the invention. In particular, a basic concept of the bridge in accordance with the present invention is configured as a plate with a number of through holes and a plurality of fasteners. In particular, FIGS. 1 and 2 illustrate a recreational board, such as a snowboard, generally identified with the reference numeral 20, that has been split into two sections 22 and 24, for example. As shown best in FIG. 2, the two sections 22 and 24 are placed together defining a joint 26.

As shown in FIG. 2, the joint 26 is shown cut at a straight vertical angle; generally ninety (90) degrees from the plane of the recreational board sections 22 and 24. It should also be understood that the joint 26 can be formed with an angled cut and that other types of joints are also considered to be within the broad scope of the invention, such as dovetail and other types of joints common in the woodworking industry.

As shown in FIGS. 1 and 2, a plate 28 is used as a one-piece bridge to secure the two recreational board sections 22 and 24 together. The one-piece bridge 28 does not require a latch since the plate is securely fastened to both sections 22, 24 of the recreational board. The plate 28 is juxtaposed to span the joint 26 and is attached to the recreational board sections 22 and 24 by way of a number of fasteners, generally identified with the reference numeral 30. As shown, the plate 28 bridges the joint 26 and strengthens the joint 26 so that its structural integrity, such as its resistance to vertical shear force, is generally the same or greater than a one-piece recreational board.

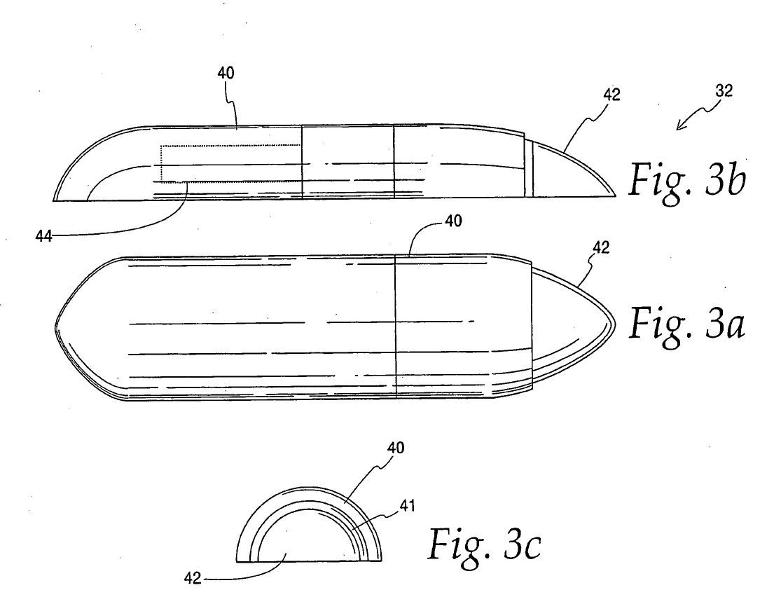

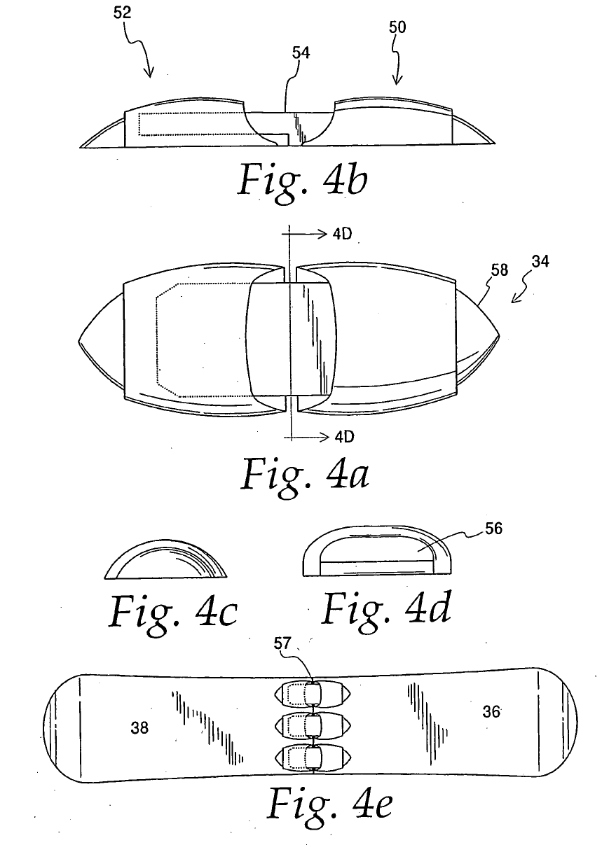

Alternate embodiments of the bridge are illustrated in FIGS. 3a-3c and 4a-4e, identified generally with the reference numerals 32 and 34, respectively. The embodiments of the bridge illustrated in FIGS. 3a-3c, 4a-4c, 5-8, 9a-9b, 10a-10b and 11a-11c are configured as two-piece complementary coupling devices. Returning to FIGS. 3a-3c and 4a-4c, both bridges 32 and 34 emulate the plate 28 and act to bridge the joint 26 (FIG. 2) between contiguous recreational board sections 22 and 24. These bridges 32 and 34 sufficiently strengthen the recreational board sections such that the assembled recreational board can withstand at least as high of a shear force as a one-piece recreational board without damage.

Both of the bridge designs 32, 34 illustrated in FIGS. 3a-3c and FIGS. 4a-4d, respectively, are adapted to be carried on the surface of the split recreational board sections, for example, sections 36 and 38 (FIG. 4e). These bridges 32 and 34 are positioned over split sections of the recreational board so as to span the joint 26.

Referring to FIGS. 3a-3c, the bridge 32 is formed from essentially two parts: a first bridge member 42 carrying a male shank 44 and a second bridge member 40 formed as a complementary female receptacle 41 (FIG. 3c). The first bridge member 42 is secured to one recreational board section (not shown) while the second bridge member 42 is secured to another recreational board section. The bridge members 40, 42 are configured so that when the recreational board sections are placed together, the male shank 44 on the bridge member 42 will be inserted into the female receptacle 41, forming a bridge across the joint.

An alternate embodiment of a bridge is illustrated in FIGS. 4a-4d and generally identified with the reference numeral 34. FIG. 4e illustrates an exemplary embodiment in which multiple bridges 34 are attached to the recreational board sections 36 and 38.

The bridge 34 includes two parts: a first bridge member 50 and a second bridge member 52. The first bridge member 50 is rigidly secured to one section of the recreational board and includes an extending male shank 54. The first and second bridge members 50, 52 are configured so that the male shank 54 is received in a complementary female receptacle 56 (FIG. 4d) formed in the second bridge member 52. As shown in FIG. 4e, the bridges 34 are positioned to span across the joint 57 between the contiguous sections 36 and 38 of the recreational board.

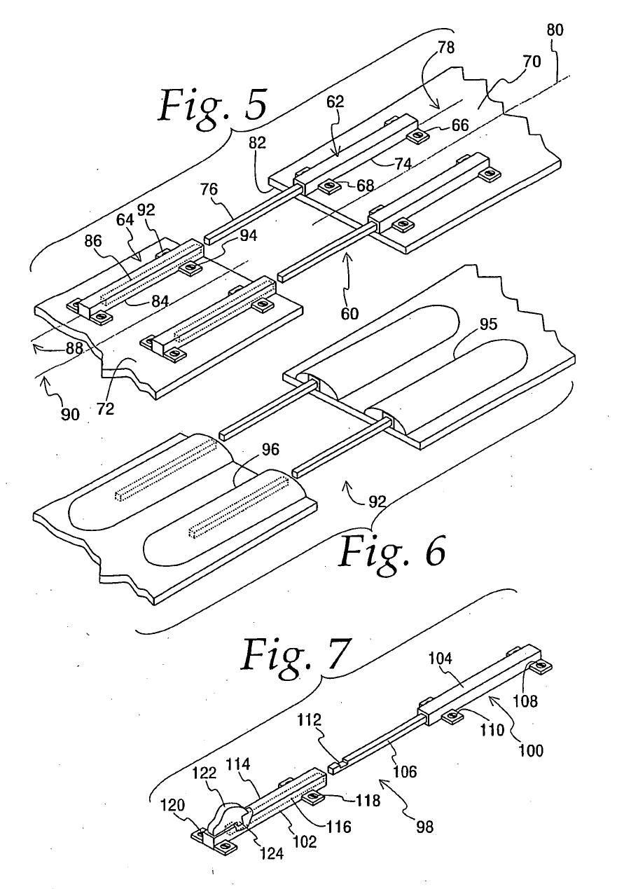

Another alternate embodiment of the bridge, in accordance with the present invention, is illustrated in FIG. 5 and generally identified with the reference numeral 60. The bridge 60 includes a first bridge member 62 and a second bridge member 64. The bridge member 62 is formed as a generally elongated rectangular member 62 with an extending shank 76. In order to enable the bridge members 62, 64 to be secured to the recreational board, each bridge member 62, 64 is formed with one or-more flanges 66. Each flange 66 is provided with a through hole for receiving a fastener 68 to enable the flange 66 and thus the bridge member 62, 64 to be fastened to a section of the recreational board.

The bridge member 62 is positioned on section 70 of the recreational board so that a longitudinal axis 78 of the elongated member 74 is generally parallel to a longitudinal axis 80 of the section 70 of the recreational board. In addition, the bridge member 62 is generally placed against an edge 82 of the recreational board section 70 such that the extending shank 76 extends outwardly therefrom.

The bridge member 64 generally includes a generally rectangular elongated member with a hole 86 defining a receptacle for the male shank 76. The bridge member 64 may be formed with one or more flanges 92. The flanges 92 are each provided with an aperture for receiving a fastener 94 to enable the bridge member 64 to be secured to the recreational board section 72. The bridge member 64 is similarly juxtaposed on the recreational board section 72 such that its longitudinal axis 88 is generally parallel to a longitudinal axis 90 of the recreational board section 72. The bridge member 64 is secured to the recreational board.

The rectangular shape of the bridge members 62-and 64, as well as the male shank 76, are merely exemplary. Virtually any cross-sectional area for the bridge member 62 and 64 are possible so long as the cross-section has a generally planar surface along its longitudinal axis to allow the bridge members 62, 64 to lay generally flat against the recreational board sections 70, 72. For example, semi-circular, triangular as well as well as other polygonal cross-sections are considered to be within the broad scope of the invention.

Similarly, the cross-sectional area of the male shank 76 is also exemplary. Various cross-sectional areas for the metal shank 76 are considered to be within the broad scope of the present invention. For example, the cross-sectional area of the metal shank 76 may be other than rectangular or square. Indeed, circular, irregular and various polygonal cross-section are considered to be within the broad scope of the invention. It is only necessary that the receptacle formed in the bridge member 64 be either complementary or otherwise configured to receive the male shank 76.

An exemplary embodiment of a snowboard constructed in accordance with the present invention may include virtually any snowboard, cut, for example, in two generally equal-length sections. The bridge 60 may be formed from various materials including virtually any metal, such as, steel, aluminum or titanium, as well as other materials which provide the requisite strength, such as, plastic and composite materials and the like. The bridge 60 may be formed as a generally square member 74, for example, a generally square steel bar, having a length of, for example, about 5 to 8 inches and a cross-section of, for example ¼ inch to 4 inches, depending on the material. The bridge member 62 may be formed as an elongated solid member having a portion with a reduced cross sectional area forming the shank 76. The bridge member 64 is formed in a similar manner but with an elongated hole, formed to receive the male shank 76.

The flanges 66, 92 may be formed from the same material as the bridge members 62, 64 and either integrally formed with the bridge members 62,64 or attached thereto by various well known methods, as shown, and configured to enable the bridge to be flush mounted on a surface of the board sections 70, 72. The flanges 66,92 may be, for example, from ½ inch to the length of the bridge members 60,62 and have a thickness, for example 1/16 inch to 1 inch depending an the required strength. The flanges 66,92 may be provided with a through hole for receiving a ⅛ to ¾ inch fastener.

The configuration of the bridge 60, as generally illustrated in FIG. 5, may be configured with the following exemplary characteristic. For example, the bridge 60 may be configured to carry a 225 pound person, standing mid board. Assuming 3 point bending, a force of 1.5 g's, and a length L =1.22 meters, the force at the midpoint, M(L/2)=F/2*L/2=225/2.2 kilograms*1.5*9.81 meters/sec²=1505 Newtons. Assuming the board is 0.01 meters thick and the bridge 60 is mounted on top of the board and the moment of inertia I= 1/12 b*h³, where the base of the board b=0.27 meters and the height of the board h=0.01 meters, the stress=My/I=1505N*(0.01/2)m/(2.25e-8m⁴)=103e6 N/m², the torque=F/2*b/2=102 Newton meters, the shear=F/4=376 Newtons and the pull axial=shear=F/4=376 Newtons.

The material and size of the material used for the bridges and shank can be used to give the boards different mechanical/performance characteristics. Moreover, the bridges may be designed such that the shanks/bridges are interchangeable to allow the board characteristics to be changed by the user/rider. For example, such a configuration may be used to allow the end user to change the shanks on the bridge so that the board can be tuned, for example, for different snow conditions.

FIG. 6 illustrates another alternate embodiment of the bridge, generally identified with the reference numeral 92. In this embodiment, the bridge is formed by a pair of complementary bridge members 94 and 96 and is similar to the embodiment illustrated in FIG. 5 and identified with the references numeral 60. The main difference is that the bridge members 94 and 96 are formed with a generally smooth surface. The smooth surface may be formed by many well-known techniques including over-molding of the bridge members 62, 64, which may be done at the time the recreational board is laminated or afterwards, for example, by covering the bridges with a composite or other material. Such a configuration enables the bridge members 92 and 94 to be used, for example, for surfboards.

FIG. 7 illustrates another alternate embodiment of a bridge in accordance with the present invention which incorporates an integral latch. This embodiment is generally identified with the reference numeral 98 and is similar to the bridge members 62, 64, discussed above. The bridge 98 includes a first bridge member 100 and a second bridge member 102. The bridge member 100 includes a generally elongated member 104 and an extending shank 106. In this embodiment, the extending shank 106 is formed with a notch 112 at one end. The bridge member 100 is formed with one or more flanges 108 to enable the bridge member 100 to be secured to a section of a recreational board by way of one or more fasteners 110.

The bridge member 102 includes an elongated member 114 that is formed with an elongated hole 116 for receiving the male shank 106. The bridge member 102 also includes one or more flanges 118 to enable the bridge member 102 to be secured to a section of a recreational board by way of one or more fasteners 120.

An exemplary moveable latch key 122 with an extending tongue 124 may be provided at one end. In this embodiment, the bridge member 102 is provided with a slot (not shown) for receiving the latch key 122. More particularly, the elongated member i 14 is configured such that the extending tongue 124 on the latch key 122 is in communication with the elongated hole 116. In an unlatched position, the extending tongue 124 on the latch key 122 is removed from the elongated hole 116 in the elongated member 114. Once the male shank 106 is inserted into the elongated hole 116, the latch key 122 can be juxtaposed so that the extending tongue 124 is captured in the notch 112 formed in the male shank 106 to prevent axial movement bridge member 100 with respect to the bridge member 102.

The latch key 122 may either be pivotally mounted on one end to enable the extending tongue 124 to be rotated into and out of communication with the elongated hole 116. In rotational embodiments, a torsion spring may be provided to bias the latch key 122 in a latched position as generally shown in FIG. 7

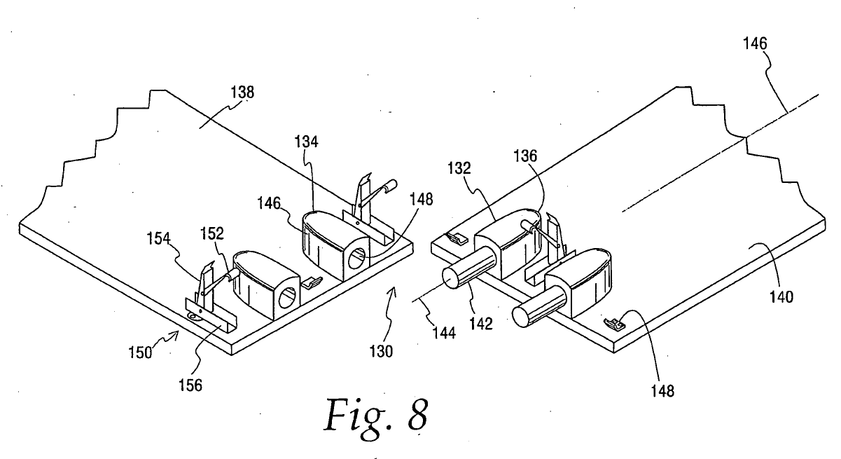

An alternate embodiment of the invention is illustrated in FIG. 8. In this embodiment, an alternate bridge is illustrated and generally identified with the referenced numeral 130. The bridge 130 includes a first bridge member 132 and a second bridge member 134. The bridge member 132 may be formed as a generally egg-shaped member 136 that is truncated at one end. In this embodiment, the underside of the bridge member 132 may be provided with threaded holes (not shown) that are adapted to be aligned with holes (not shown), for example, counter-sunk holes, formed in the underside of the recreational board section 140. Such a configuration allows the bridge member 132 to be secured to the recreational board section 140 respectively by way of fasteners (not shown) that are inserted into the underside of the recreational board section 140.

The bridge member 132 is formed with an extended male shank 140. The extended male shank 140 may be formed with a generally circular cross section. The bridge member 132 is juxtaposed on the recreational board section 140 so that a longitudinal axis 144 of the extended metal shank 140 is generally parallel with a longitudinal axis 146 of the recreational board section 140.

The bridge member 134 is similarly formed With a generally egg-shaped member 146 truncated at one end, which may be juxtaposed relative to the recreational board section 138 and connected and rigidly secured thereto in the same manner as discussed above. The bridge member 134 is provided with a central hole 148 defining a female receptacle for receiving the extended male shank 142.

In the embodiment illustrated in FIG. 8, a separate exemplary latch mechanism 150 is utilized. The latch mechanism 150 may include a catch 148, rigidly attached one of the recreational board sections 138, 140. The catch 148 is formed with a generally horizontal bar. When the recreational board section 138, 140 are placed together the catch is adapted to be captured by a latch mechanism 150 rigidly secured to the adjoining or contiguous section 138 of the recreational board. The latch mechanism 150 includes an extending lever 152 which is hooked at one end. The hooked end of the lever 152 is adapted to capture the horizontal bar of the catch 148. The lever 152 is pivotally mounted to a second lever 154, which, in turn, is pivotally mounted to a base member 156. When the sections 138,140 of the recreational board are placed together, the hooked portion of the lever 152 captures the horizontal rod on the catch 148. The other lever 154 is then rotated in a counter clockwise direction until the latch mechanism 156 is in a latched position.

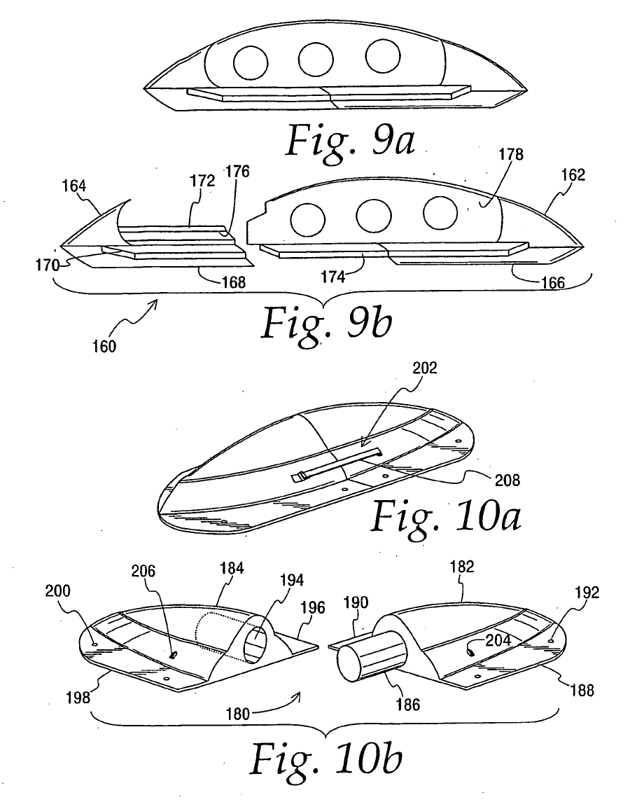

An alternate bridge in accordance with the present invention is illustrated in FIGS. 9a and 9b and generally identified with the referenced numeral 160. The bridge 160 includes a first bridge member 162 and a second bridge member 164. For added stability, the bridge members 162 and 164 may be formed with keels 166 and 168 respectively. These keels 166,168 are adapted to be received in elongated slots (not shown) formed in the sections of the recreational board. Each bridge member 166,168 is formed with a flange 170 on each side. The flanges 170, 172 are configured with through holes (not shown) for receiving fasteners to fasten the bridge members 162, 164 to the sections of the recreational board.

The bridge member 162 includes an extended flange portion 174, formed as a generally rectangular plate. The extended flange portion 174 is configured to be received in a slot 176 formed in the bridge member 164. The bridge member 162 also includes a vertical plate portion 178. The vertical plate portion 178 provides additional strength to the bridge 160.

FIGS. 10a and 10b illustrate an alternate embodiment of the bridge, generally identified with the reference numeral 180. The bridge 180 includes a bridge member 182 and a bridge member 184. The bridge member 182 is formed with an irregular shape having a generally smooth surface with an extending male shank 186. The bridge member 182 includes a pair of flanges 188 and 190. The flanges 188 and 190 are formed with through holes 192 for receiving fasteners (not shown) to enable the bridge member 182 to be secured to a section of a recreational board.

The bridge member 184 includes a generally irregular shape, smooth base member with an elongated hole 194. The elongated hole 194 defines a receptacle for receiving the extended male shank 186. The bridge member 184 also includes a flange 196 and 198 on each side. The flanges 196,198 are provided with through holes 200 to enable the bridge member 184 to be secured in place with fasteners (not shown).

The bridge 180 may also be formed with an integral latch mechanism 202. The latch mechanism 202 may be formed from a pair of slots 204, 206 which may be formed on each side of the bridge members 182 and 184. A flexible metal strap 208 with hooked ends may be used to secure bridge members 182 and 184 together.

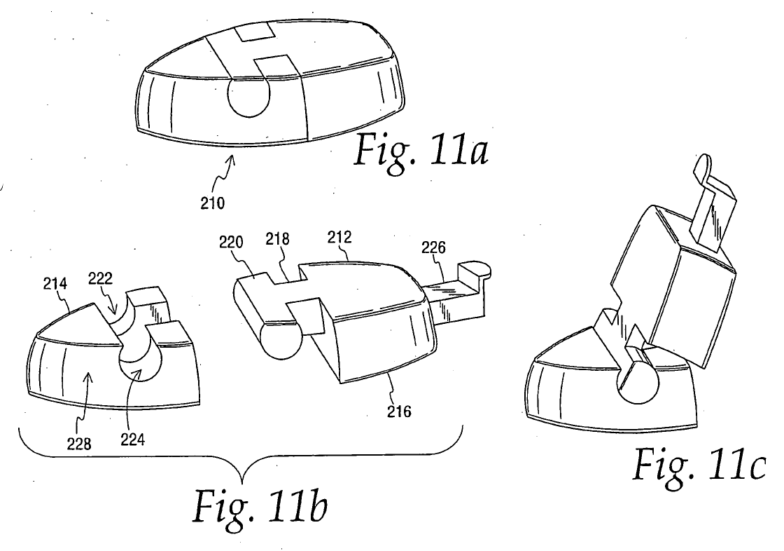

An alternate bridge with an integral latch is illustrated in FIGS. 11 a-11 c and generally identified with the reference numeral 210. The bridge 210 includes a bridge member 212 and a bridge member 214. These bridge members 212, 214 may be formed with threaded holes on the underside to enable the members 212, 214 to be fastened to sections of a recreational board with suitable fasteners (not shown).

The bridge member 212 is formed with a base section 216 and on extending shank 218. An irregular shaped latch member 220 is formed at the end of the extending shank 218. The extending latch member 220 is formed with a generally circular cross section with a planar surface.

The latch member 220 is adapted to be received in a pair of irregularly shaped notches 220, 224 formed in the bridge member 214. As best shown in FIG. 11c, the recreational board sections are brought together, the sections of the recreational board are manipulated so that the bridge member 212 (including the recreational board section to which it is attached) is rotated upwardly to allow the latch member 22 to be received into the irregularly shaped notches 220, 224 in the bridge member 214. As the bridge member 212 is rotated in a clockwise direction the latch member 220 becomes captured within the regular shaped notches 222, 224 to its latched position as shown in FIG. 11a.

The bridge member 212 may be provided with a deadbolt 226 which is slideably received within the bridge member 212. The deadbolt 226 is adapted to be received in a generally square aperture in a bow portion 228 of the bridge member 214.

The bridge members 212 and 214 may be formed with threaded apertures (not shown). These threaded apertures may be aligned through holes formed in sections of the recreational board to enable the bridge members 212, 214 to be secured thereto.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. A coupling device for coupling multiple sections of a recreational board together, the coupling device comprising:
one or more bridges, configured to be carried by the surfaces of said multiple board sections and positioned to span a joint defined by contiguous sections of said recreational board; and
a plurality of fasteners for securing said one or more bridges to said surfaces of said recreational board.

2. The coupling device as recited in claim 1, wherein at least one of said one or more bridges is formed as a one-piece member.

3. The coupling device as recited in claim 1, wherein at least one of said one or more bridges includes at least a first bridge member and a second bridge member.

4. The coupling device as recited in claim 3, wherein said first bridge member and said second bridge member are configured as complementary coupling members

5. The coupling device as recited in claim 4, wherein said first bridge member includes an extending shank and said second bridge member that includes a complementary elongated hole for receiving said extending shank.

6. The coupling device as recited in claim 4, wherein said first bridge member includes an extending shank formed as a generally rectangular plate and said second bridge member is formed with a slot for receiving said generally rectangular plate.

7. The coupling device as recited in claim 1, wherein said coupling device includes an integral latch mechanism.

8. A multiple-section recreational board comprising:
a recreational board formed in two or more contiguous sections defining a joint therebetween;
a bridge carried by said contiguous sections for coupling said contiguous sections together; and
a latch mechanism for latching said contiguous sections together.

9. The multiple-section recreational board as recited in claim 8, wherein said latch mechanism is integrally formed with said bridge.

10. The multiple-section recreational board as recited in claim 8, wherein said latch mechanism is separate from said bridge.

11. The multiple-section recreational board as recited in claim 10, wherein said bridge includes a first bridge member and a second bridge member.

12. The multiple-section recreational board as recited in claim 11, wherein said first bridge member and said second bridge member are formed as complementary coupling devices.

13. A method for making a multiple-section recreational board comprising the steps of:
(a) forming a recreational board in multiple contiguous sections; and
(b) attaching one or more bridges across each joint defined by contiguous sections.

14. The method as recited in claim 13, wherein step (b) comprises attaching a first bridge member to one section and a complementary bridge member to a contiguous section.

15. The method as recited in claim 12, further including step (c): providing at least one latch mechanism for securing said contiguous sections together.

16. A multiple section recreation board comprising:
at least two recreational board sections configured to be juxtaposed end to end defining a joint; and
a bridge device disposed over said joint and rigidly secured to the surface of each of said at least two recreational board sections.

17. The multiple section recreation board as recited in claim 16, wherein said bridge device comprises a two-piece coupling device defining a first coupling member and a second coupling member, wherein said first coupling member is rigidly secured to the surface of said at least one of said at least two recreational board sections and said second coupling member is rigidly secured to the surface of another one of said at least two recreational board members.

18. The multiple section recreation board as recited in claim 17, wherein said first and second coupling members are complementary.

19. The multiple section recreation board as recited in claim 18, wherein said first coupling member is formed as a male shank and said second coupling member is formed as a complementary receptacle.

20. The multiple section recreation board as recited in claim 16, wherein said recreational board is a snow-board.

21. The multiple section recreation board as recited in claim 17, further including a latch for securing said at least two snowboard sections together when said first and second coupling devices are mated together.
